(19) United States
(12) Patent Application Publication
(10) Pub. No.: US 2004/0083268 A1
(43) Pub. Date: Apr. 29, 2004

(54) Methods and apparatuses for interfacing portable devices with digital sender devices

(76) Inventor: Arti Shukla, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/281,628

(22) Filed: Oct. 28, 2002

(51) Int. Cl. G06F 15/16

(52) U.S. Cl. 709/206; 709/246

(57) ABSTRACT

Methods and apparatuses are provided for interfacing portable devices with digital sender devices. Accordingly, a portable device can send and receive e-mail or other like message data through a digital sender device. The e-mail that is sent from the portable device can be selectively modified by the digital sender device to include scanned object data produced by the digital sender device or other e-mail information. The digital sender device may be included within a multiple function peripheral (MFP) device.

### TECHNICAL FIELD

The present invention relates generally to computing and communication devices and more particularly to methods and apparatuses for interfacing portable devices with digital sender devices.

### BACKGROUND

Electronic messaging, such as, sending and receiving electronic mail (e-mail) continues to grow in popularity. There is growing list of devices that can be used to send and/or receive e-mail. It is not uncommon, for example, to find e-mail being exchanged between users of personal computers (PCs) and users of mobile telephones/pagers.

A more recent development has been the introduction of devices sometimes referred to as digital senders. Digital sender devices basically allow users to send e-mail to one or more other users by entering the other user(s) e-mail addresses and/or selecting a defined list of recipients. The user then scans one or more documents using the digital sender device. The digital sender then forwards a digital representation of the scanned documents to the listed recipients over an interconnecting network.

Digital sender devices such as this are useful, for example, in offices, conference rooms, business centers, home offices, schools, and other like settings where it would be beneficial to enable users to quickly send e-mails without requiring a more extensive computing arrangement. Digital senders can be especially useful to visitors that may not have the ability to access local computing networks, etc. Many visitors and other mobile users do carry portable devices, such as, for example, notebook computers, personal digital assistants (PDAs), mobile telephones/pagers, and the like. It would be beneficial if such portable devices could interact with digital sender and other like devices.

Consequently, there is a need for improved methods and apparatuses that interface portable devices with digital sender devices.

### SUMMARY

The above-stated needs and/or others are met, for example, by a method that includes configuring a digital sender device to receive message data from a portable device that is sent over a communication link between the digital sender and the portable device. The message data is configured to be sent from a user of the portable device to at least one user of a remote device. The method further includes causing the digital sender device to: optically scan at least one object and produce corresponding scanned object data; combine the scanned object data and the message data to form corresponding modified message data; and output the modified message data to at least one communication network connected to the remote device. The modified message data is configured to be sent over the communication network to the remote device.

In accordance with other exemplary implementations, an apparatus is provided that includes at least one communication port, a scanning mechanism, at least one network interface, and logic. The communication port is configured to receive message data from a portable device over a communication link. The scanning mechanism is configurable to optically scan at least one object and produce corresponding scanned object data. The network interface is configurable to connect to at least one communication network. The logic is operatively coupled to the communication port, the scanning mechanism and the network interface and is configured to combine the scanned object data and the received message data to form corresponding modified message data. The modified message data is then provided to the network interface.

### BRIEF DESCRIPTION OF THE DRAWINGS

A more complete understanding of the various methods and apparatuses of the present invention may be had by reference to the following detailed description when taken in conjunction with the accompanying drawings wherein:

FIG. 1 is a block diagram depicting a computing and communication environment having a digital sender device and a portable device, in accordance with certain exemplary implementations of the present invention.

FIG. 2 is a flow diagram depicting a method for use in a computing and communication environment having a digital sender device and a portable device as in FIG. 1, for example, in accordance with certain exemplary implementations of the present invention.

### DETAILED DESCRIPTION

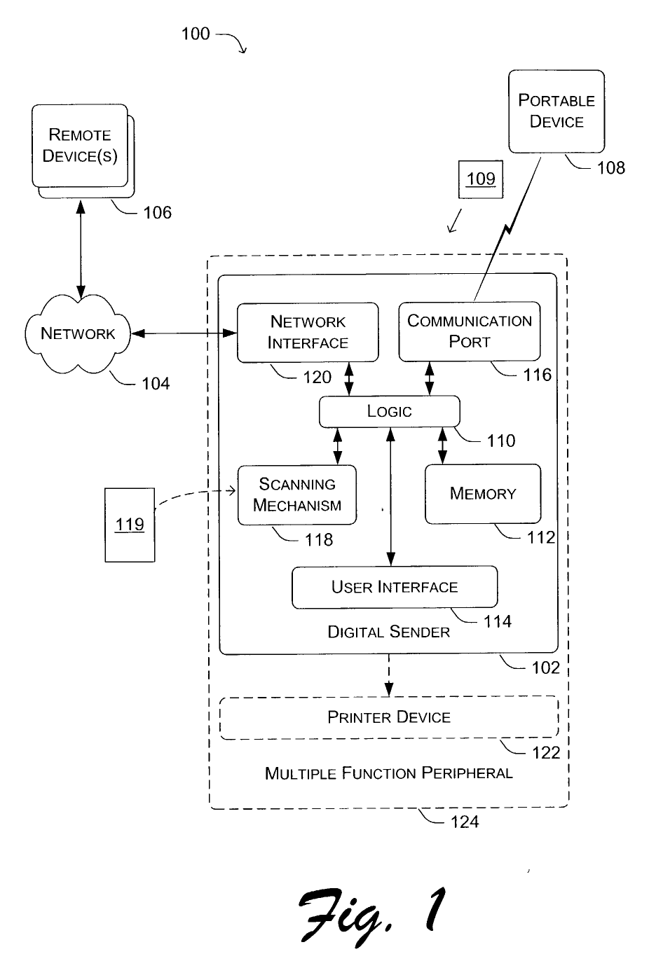

FIG. 1 is a block diagram depicting an exemplary computing and communication environment 100 having a digital sender device 102 that is connected to a network 104, which is further connected to one or more remote devices 106. Digital sender device 102 is also illustrated as being connected to a portable device 108 by way of a wireless communication link.

Network 104 is representative of one or more communication links, either wired or wireless that are capable of carrying data between digital sender 102 and at least one remote device 106. In certain exemplary implementations, network 104 includes a local area network (LAN), a wide area network (WAN), an intranet, the Internet, or other similar network.

Remote device 106 is representative of any device that is capable of exchanging data over network 104. Thus, by way of example, remote device 106 may include a personal computer (PC) or a server computer or perhaps even another digital sender device and/or portable device.

Here, digital sender device 102 is configured to allow a user to scan an object(s) 119, such as, e.g., a document and send the resulting scanned object data out over network 104 to one or more remotes devices 106 in the form of message data. The message data may, for example, include an electronic mail (i.e., e-mail) message data from the user of the digital sender device 102 to the user(s) of the remote device(s) 106. Here, an e-mail message would include the scanned object data in some manner.

For example, the scanned object data may be included in the e-mail message as an attached file. The scanned object data may include Portable Document Format (PDF) formatted data, tagged image file format (TIFF) formatted data, Joint Photographic Experts Group (JPEG) formatted data, bit-map formatted data, optical character recognition (OCR) related data, American Standard Code for Information Interchange (ASCII) formatted data, and/or other forms of encoded data, including, e.g., encrypted data, etc.

Digital sender 102 includes a user interface 114 that is configured to allow the user to input information and/or make selections associated with the operation of digital sender device 102. By way of example, user interface 114 may include a keypad or keyboard and/or display (not shown). The display, for example, may include a liquid crystal display (LCD) or the like. In certain implementations the display may include a touch-screen input/output device. Thus, with user interface 114, the user can be prompted to enter user input data, such as, e.g., the recipient(s) e-mail address information, the subject of the e-mail, the text, or body of the e-mail, etc. The user input data may also control the operation of digital sender 102.

As further illustrated in FIG. 1, digital sender 102 is also configured, in accordance with certain aspects of the present invention, to allow a user of a portable device 108 to send message data 109 through network 104 to one or more remote devices 106 using digital sender 102 as an intelligent interface with network 104. In accordance with certain other aspects of the present invention, digital sender 102 is further configured to allow the user of portable device 108 to receive message data, for example, sent from one or more remote devices 106 over network 104.

Portable device 108 is representative of any electronic device capable of sharing data with digital sender 102 over either a wireless or wired communication link. Thus, for example, portable device 108 may include a portable handheld computer, a notebook computer, a personal digital assistant (PDA), a wearable computer device, a mobile telephone, a pager, a two-way radio, a media player device, a digital camera device, and other like electronic devices.

With regard to messages sent from the user of portable device 108 to one or more users of remote devices 106, at times digital sender device 102 simply acts as a basic message forwarding service, that for the most part simply passes the message data on through to network 104 for further routing to remote device 106 without purposefully changing the information content of the message data.

At other times, digital sender device actually modifies the information content of the message data that is received from portable device 108. For example, in accordance with certain exemplary implementations of the present invention, at least a portion of the scanned object data is included in the message data before it is sent to remote device(s) 106 via network 104. Thus, in certain instances the scanned object data may be attached as a file(s) to an e-mail message that was generated by portable device 108. In other instances, the scanned object data may be incorporated into existing content. For example, a scanned photo image may be added to the body of an e-mail message that was received from portable device 108.

In this manner, a user of a portable device 108 is able to take advantage of not only the network access provided by digital sender 102, but also the monochrome and/or color scanning capability of digital sender device 102.

In accordance with certain other aspects of the present invention, digital sender device 102 may also be configured to provide a copy of the resulting modified message data back to portable device 108, for example, over the wireless communication link there between.

In accordance with still other aspects of the present invention, digital sender device 102 may be included within a multiple function peripheral (MFP) device 124. As its name implies, MFP device 124 is configured to provide multiple functions. In this example, the functions provided by MFP device 124 include those provided by digital sender device 102 and a printer device 122. Consequently, the user of digital sender device 102 and/or portable device 108 may also print out a hardcopy of any applicable portions of the message data. Furthermore, the user may also request print outs of other files, as well. For example, all or part of the scanned object data may be printed or other files sent from portable device 108 may be printed.

To accomplish the various exemplary tasks as described above and others, digital sender 102 includes logic 110, which is operatively coupled to memory 112, a user interface 114, at least one communication port 116, a scanning mechanism 118, and at least one network interface 120. When included in MFP device 124, logic 110 would also be operatively coupled to printer device 122, for example.

Logic 110 is representative of any hardware, firmware and/or software that is configured to perform certain functions associated with the operation of digital sender 102 and, if applicable, MFP 124. Hence, as those skilled in the art will recognize, logic 110 may include dedicated logic and/or one or more processors configured in accord with software instructions, for example.

Memory 112 is representative of any type of data storage mechanism that can be accessed by at least logic 110. Memory 112 may therefore include, for example, some form of random access memory (RAM), some form of read only memory (ROM), and/or other like solid-state data storage mechanism. Memory 112 may include magnetic and/or optical data storage mechanism.

Scanning mechanism 118 is representative of any optical scanner technology that may be employed to produce scanned object data upon scanning an object. Such scanning technologies are well known. The resulting scanned object data is provided to logic 110 and/or stored in memory 112.

Network interface 120 is representative of any communication technology that allows data to be shared between logic 110 and/or memory 112 and network 104. Such communication technology is well known. Similarly, communication port 116 is representative of any communication technology that allows data to be shared between logic 110 (and/or memory 112) and portable device 108. Communication port 116 may be configured to provide a wired and/or a wireless communication link to corresponding communication technology (not shown) within portable device 108. In certain implementations, the resulting communications link may include an infrared communications link, for example. Again, such communication technology is well known and beyond the scope of this description.

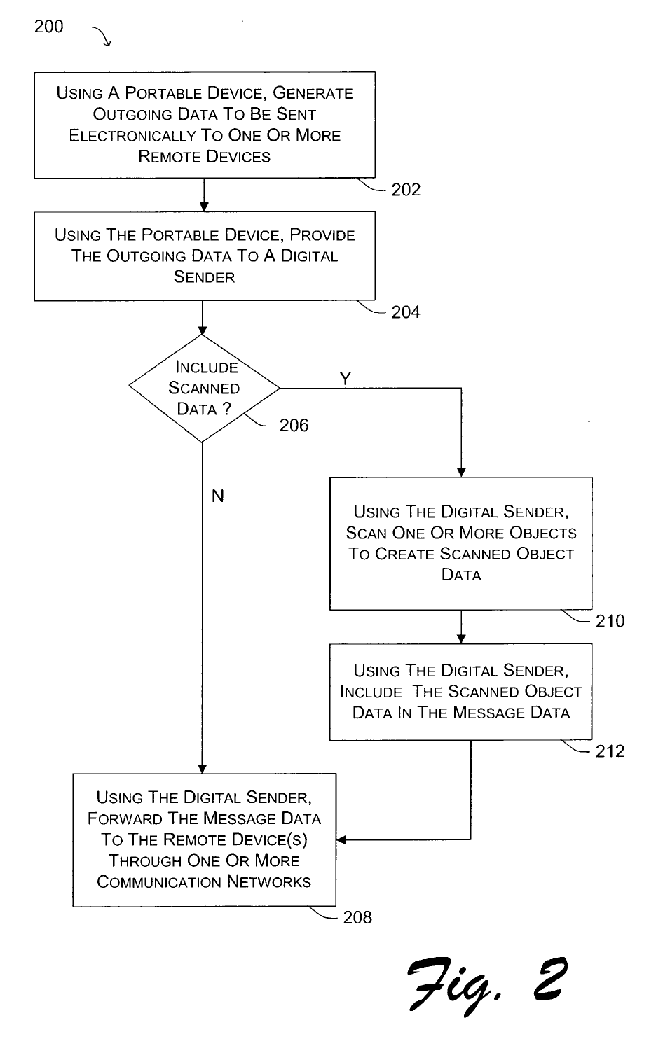

With this in mind, logic 110 is configured to perform the operations described above. By way of further example, a flow diagram is depicted in FIG. 2 to illustrate certain exemplary functions that can be performed using logic 110 and the other resources in digital sender 102. Here, a process 200 is provided.

In step 202, outgoing data is generated by portable device 108. The outgoing data includes message data that is to be sent to at least one user/account associated with a remote device 106. In step 204, portable device 108 provides the outgoing data is provided to digital sender device 102.

Step 206 represents a decision that is made as to whether the message data that will eventually be sent by digital sender device 102 to remote device 106 will include scanned object data, too. The decision that is made in step 206 may be based, for example, on user input that has been interactively and/or previously collected by user interface 114 and/or on applicable selection data included in the outgoing data from portable device 108.

However made, if the decision in step 206 is that no scanned object data will be included in the resulting message data that is sent from digital sender device 102 to remote device 106, then process 200 moves to step 208 wherein the digital sender device 102 sends the resulting message data to remote device 106 over network 104.

If the decision in step 206 is that scanned object data will be included in the resulting message data that is sent from digital sender device 102 to remote device 106, then process 200 moves instead to step 210. In step 210, if an object to be scanned has not already been scanned, then it is scanned to produce corresponding scanned object data. For example, as part of step 210, logic 110 may cause user interface 114 to ask the user if they are ready to scan object 119, gather applicable input data from the user and initiate a scanning process using scanning mechanism 118.

In step 212, scanned object data is included in the resulting message data. In step 208, the “modified” data is then sent over network 104 to remote device(s) 106.

In accordance with certain further exemplary implementations of the present invention, logic 110 may be configured to prompt a user of the digital sender for user input that includes additional modifying message data altering information. In response to the inputted information (i.e., additional modifying data) logic 110 would, for example, in step 212 to combine the scanned object data, the message data and the additional modifying data to form the resulting modified message data. The additional modifying data may include, for example, e-mail address data, Internet Protocol (IP) address data, e-mail subject data, and/or e-mail text data.

Thus, although some preferred embodiments of the various methods and apparatuses of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A method comprising:
operatively configuring a digital sender device to receive outgoing data over a communication link between said digital sender and a portable device, said outgoing data including message data being sent from a user of said portable device to at least one user of a remote device;
causing said digital sender to combine scanned object data and said message data to form corresponding modified message data; and
causing said digital sender to output said modified message data to at least one communication network connected to said at least one remote device, said modified message data being configured to be sent over said communication network to said remote device.

2. The method as recited in claim 1, further comprising:
causing said digital sender device to optically scan at least one object and produce corresponding said scanned object data.

3. The method as recited in claim 1, wherein causing said digital sender device to optically scan said at least one object and produce said corresponding scanned object data further includes:
causing said digital sender device to prompt a user of said digital sender for user input; and
receiving said user input, and in response to said user input causing said digital sender device to optically scan said at least one object and produce said corresponding scanned object data.

4. The method as recited in claim 1, wherein causing said digital sender to combine said scanned object data and said message data to form said corresponding modified message data further includes:
causing said digital sender device to prompt a user of said digital sender for user input, said user input including additional modifying data; and
receiving said user input, and in response to said user input causing said digital sender device to combine said scanned object data, said message data and additional modifying data to form said corresponding modified message data.

5. The method as recited in claim 4, wherein said additional modifying data includes data selected from a group of data comprising electronic mail address data, Internet Protocol (IP) address data, electronic mail subject data, and electronic mail text data.

6. The method as recited in claim 1, wherein said communication link includes a wireless communication link.

7. The method as recited in claim 6, wherein said wireless communication link includes an infrared communication link.

8. The method as recited in claim 1, wherein said portable device is selected from a group of portable devices comprising a portable handheld computer, a notebook computer, a personal digital assistant (PDA), a wearable computer device, a mobile telephone, a pager, a two-way radio, a media player device, and a digital camera device.

9. The method as recited in claim 1, wherein said digital sender device is included within a multiple function peripheral (MFP) device that further includes a printer device.

10. The method as recited in claim 1, further comprising:
operatively configuring said digital sender device to further send said modified message data to said portable device over said communication link.

11. The method as recited in claim 1, wherein said message data includes electronic mail message data and said modified message data includes modified electronic mail data.

12. An apparatus comprising:
at least one communication port operatively configured to receive message data from a portable device over a communication link, said message data being sent from a user of said portable device to at least one user of a remote device;
at least one network interface configurable to connect to at least one communication network that is operatively connected to said at least one remote device;
logic operatively coupled to said at least one communication port and said at least one network interface, said logic being configured to combine scanned object data and said received message data to form corresponding modified message data, and provide said modified message data to said at least one network interface, where upon said at least one network interface is configurable to output said modified electronic mail to said at least one communication network, said modified message data being configured to be sent over said at least one communication network to said remote device.

13. The apparatus as recited in claim 12, further comprising:
a scanning mechanism operatively coupled to said logic and configurable to optically scan at least one object and produce corresponding said scanned object data.

14. The apparatus as recited in claim 12, further comprising:
a user interface operatively coupled to said logic, and
wherein said logic is further configured to prompt a user of said apparatus for user input via said user interface and said user interface accept said user input and provides user input data associated with said user input to said logic, and in response to said user input data said logic causes said scanning mechanism to optically scan said at least one object and produce said corresponding scanned object data.

15. The apparatus as recited in claim 12, wherein said user input data includes additional modifying data, and wherein said logic combines said scanned object data, said message data and additional modifying data to form said corresponding modified message data.

16. The apparatus as recited in claim 14, wherein said additional modifying data includes data selected from a group of data comprising electronic mail address data, Internet Protocol (IP) address data, electronic mail subject data, and electronic mail text data.

17. The apparatus as recited in claim 12, wherein said communication link includes a wireless communication link.

18. The apparatus as recited in claim 17, wherein said wireless communication link includes an infrared communication link.

19. The apparatus as recited in claim 12, wherein said portable device is selected from a group of portable devices comprising a portable handheld computer, a notebook computer, a personal digital assistant (PDA), a wearable computer device, a mobile telephone, a pager, a two-way radio, a media player device, and a digital camera device.

20. The apparatus as recited in claim 12, wherein said apparatus is included within a multiple function peripheral (MFP) device that further includes a printer device that is operatively coupled to said logic.

21. The apparatus as recited in claim 12, wherein said logic is further configured to provide said modified message data to said at least one communication port, and wherein said at least one communication port is further configurable to send said modified message data to said portable device over said communication link.

22. The apparatus as recited in claim 12, further comprising:
memory operatively coupled to said logic and configured to store data selected from a group of data comprising said message data, said scanned object data and said additional modifying data.

23. The apparatus as recited in claim 12, wherein said message data includes electronic mail data and said modified message data includes modified electronic mail data.

24. A computer-readable medium having computer-executable instructions for causing logic to perform acts comprising:
operatively configuring a digital sender device to receive outgoing data over a communication link between said digital sender and a portable device, said outgoing data including message data being sent from a user of said portable device to at least one user of a remote device;
causing said digital sender to combine scanned object data and said message data to form corresponding modified message data; and
causing said digital sender to output said modified message data to at least one communication network connected to said at least one remote device, said modified message data being configured to be sent over said communication network to said remote device.

25. The computer-readable medium as recited in claim 24, further comprising:
causing said digital sender device to optically scan at least one object and produce corresponding said scanned object data.

26. The computer-readable medium as recited in claim 24, wherein causing said digital sender device to optically scan said at least one object and produce said corresponding scanned object data further includes:
causing said digital sender device to prompt a user of said digital sender for user input; and
receiving said user input, and in response to said user input causing said digital sender device to optically scan said at least one object and produce said corresponding scanned object data.

27. The computer-readable medium as recited in claim 24, wherein causing said digital sender to combine said scanned object data and said message data to form said corresponding modified message data further includes:
causing said digital sender device to prompt a user of said digital sender for user input, said user input including additional modifying data; and
receiving said user input, and in response to said user input causing said digital sender device to combine said scanned object data, said message data and additional modifying data to form said corresponding modified message data.

28. The computer-readable medium as recited in claim 27, wherein said additional modifying data includes data selected from a group of data comprising electronic mail address data, Internet Protocol (IP) address data, electronic mail subject data, and electronic mail text data.

29. The computer-readable medium as recited in claim 24, wherein said communication link includes a wireless communication link.

30. The computer-readable medium as recited in claim 29, wherein said wireless communication link includes an infrared communication link.

31. The computer-readable medium as recited in claim 24, wherein said portable device is selected from a group of portable devices comprising a portable handheld computer, a notebook computer, a personal digital assistant (PDA), a wearable computer device, a mobile telephone, a pager, a two-way radio, a media player device, and a digital camera device.

32. The computer-readable medium as recited in claim 24, wherein said digital sender device is included within a multiple function peripheral (MFP) device that further includes a printer device.

33. The computer-readable medium as recited in claim 24, having further computer-executable instructions for causing logic to perform acts comprising:
operatively configuring said digital sender device to further send said modified message data to said portable device over said communication link.

34. A computing device operatively configured to access a computer-readable medium having computer-executable instructions for causing logic to perform acts comprising:
operatively configuring a digital sender device to receive outgoing data over a communication link between said digital sender and a portable device, said outgoing data including message data being sent from a user of said portable device to at least one user of a remote device;
causing said digital sender to combine scanned object data and said message data to form corresponding modified message data; and
causing said digital sender to output said modified message data to at least one communication network connected to said at least one remote device, said modified message data being configured to be sent over said communication network to said remote device.

35. The computing device as recited in claim 34, wherein said acts further include:
causing said digital sender device to optically scan at least one object and produce corresponding said scanned object data.

36. The computing device as recited in claim 34, wherein causing said digital sender device to optically scan said at least one object and produce said corresponding scanned object data further includes:
causing said digital sender device to prompt a user of said digital sender for user input; and
receiving said user input, and in response to said user input causing said digital sender device to optically scan said at least one object and produce said corresponding scanned object data.

37. The computing device medium as recited in claim 34, wherein causing said digital sender to combine said scanned object data and said message data to form said corresponding modified message data further includes:
causing said digital sender device to prompt a user of said digital sender for user input, said user input including additional modifying data; and
receiving said user input, and in response to said user input causing said digital sender device to combine said scanned object data, said message data and additional modifying data to form said corresponding modified message data.

38. An system comprising:
means for operatively configuring a digital sender device to receive outgoing data over a communication link between said digital sender and a portable device, said outgoing data including message data being sent from a user of said portable device to at least one user of a remote device;
means for causing said digital sender to combine scanned object data and said message data to form corresponding modified message data; and
means for causing said digital sender to output said modified message data to at least one communication network connected to said at least one remote device, said modified message data being configured to be sent over said communication network to said remote device.

39. The system as recited in claim 38, further comprising:
means for causing said digital sender device to optically scan at least one object and produce corresponding said scanned object data.

40. The system as recited in claim 38, wherein said means for causing said digital sender device to optically scan said at least one object and produce said corresponding scanned object data further includes:
means for causing said digital sender device to prompt a user of said digital sender for user input; and
means for receiving said user input, and in response to said user input causing said digital sender device to optically scan said at least one object and produce said corresponding scanned object data.

41. The system as recited in claim 38, wherein said means for causing said digital sender to combine said scanned object data and said message data to form said corresponding modified message data further includes:
means for causing said digital sender device to prompt a user of said digital sender for user input, said user input including additional modifying data; and
means for receiving said user input, and in response to said user input causing said digital sender device to combine said scanned object data, said message data and additional modifying data to form said corresponding modified message data.

42. The system as recited in claim 41, wherein said additional modifying data includes data selected from a group of data comprising electronic mail address data, Internet Protocol (IP) address data, electronic mail subject data, and electronic mail text data.

43. The system as recited in claim 38, wherein said communication link includes a wireless communication link.

44. The system as recited in claim 43, wherein said wireless communication link includes an infrared communication link.

45. The system as recited in claim 38, wherein said portable device is selected from a group of portable devices comprising a portable handheld computer, a notebook computer, a personal digital assistant (PDA), a wearable computer device, a mobile telephone, a pager, a two-way radio, a media player device, and a digital camera device.

46. The system as recited in claim 38, wherein said digital sender device is included within a multiple function peripheral (MFP) device that further includes a printer device.

47. The system as recited in claim 38, further comprising:
means for operatively configuring said digital sender device to further send said modified message data to said portable device over said communication link.

48. The system as recited in claim 38, wherein said message data includes electronic mail message data and said modified message data includes modified electronic mail data.
